(19) United States
(12) Patent Application Publication
(10) Pub. No.: US 2009/0225987 A1
(43) Pub. Date: Sep. 10, 2009

(54) Key rotation

(75) Inventors: Brian Metzger, San Jose, CA (US); Stephen Mauldin, San Francisco, CA (US); Bruce Sandell, Mountain View, CA (US); Jorge Chang, Santa Clara, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: SafeNet, Inc.

(21) Appl. No.: 12/384,256

(22) Filed: Apr. 2, 2009

Related U.S. Application Data
(62) Division of application No. 11/236,046, filed on Sep. 26, 2005.

(51) Int. Cl. H04L 9/08

(52) U.S. Cl. 380/278

(57) ABSTRACT

A system and method for a mechanism is provided for automatically selecting a new encryption key for re-encrypting data in a target database. New initialization vectors may be specified for re-encrypting each column of data selected for re-encryption. Further, a new initialization vector may be specified for one or more rows of data of a database table in the target database that is selected for re-encryption.

### CROSS-REFERENCE TO RELATED APPLICATIONS

This application is a divisional of co-pending U.S. patent application Ser. No. 11/236,046, filed Sep. 26, 2005, which claims the benefit of priority to U.S. patent application Ser. Nos. 11/236,061 and 11/236,294, concurrently filed on Sep. 26, 2005, which are incorporated in their entirety by reference herein.

### TECHNICAL FIELD

The present invention is directed to data security, and more specifically to protecting sensitive data that resides in a database and providing a mechanism for automating the re-encryption of selected data of the database using new encryption keys in order to further secure database with little or no impact on the database and on the applications that access the database.

### BACKGROUND

It cannot be gainsaid that confidential information, such as credit card numbers, social security numbers, patient records, insurance data, etc., need to be protected. Although enterprises have instituted procedures for protecting such sensitive data when such data is in transit, more often than not, such data is stored in unencrypted format (“clear text” or “plain text”). For example, data is often stored as clear text in databases. The clear text is visible to attackers and disgruntled employees who can then compromise the data and/or use the data illegitimately. Further, not only is data security a feature that is highly desired by customers but it is also needed to comply with certain data security regulations. In order to adequately protect data, organizations need to institute procedures to protect data at all times including when the data is in storage, when the data is in transit, and when the data is being used.

Once the data in a target database has been encrypted, security of the data can be further enhanced by periodically re-encrypting the data in the database. It is desirable to automate the re-encryption process with as little impact on the administrator of the target database and/or the applications that access the target database.

### BRIEF DESCRIPTION OF THE DRAWINGS

FIG. 1 is a high-level block diagram that illustrates a system architecture for encryption of data in a database using an encryption mechanism that is separate from the database, according to certain embodiments.

FIG. 2 is a flowchart that illustrates some of the steps that are performed for converting sensitive data that is stored in clear text format in a target relational database into encrypted format in a manner that has minimal impact on the resources of the target relational database.

### DETAILED DESCRIPTION

According to certain embodiments, an unsecured relational database system is first converted to a secure system by providing mechanisms for converting existing data that resides in the relational database into encrypted format with minimal impact to the resources of the relational database. According to certain embodiments, after the relational database is converted to a secure system, the security of such a relational database is further enhanced by periodically re-encrypting the data in the database using new encryption keys. The periodic re-encryption of data in the database using new encryption keys is herein referred to as key rotation.

According to certain embodiments, a mechanism is provided for automatically selecting a new encryption key for re-encrypting data in the target database. According to certain embodiments, new initialization vectors may be specified for re-encrypting each column of data selected for re-encryption. According to certain embodiments, a new initialization vector may be specified for one or more rows of data in a database table that is selected for re-encryption.

According to certain embodiments, the mechanism that is used for automatically re-encrypting data in the target database includes the following functionality: 1) allow a user to select one or more previously encrypted columns for re-encryption, 2) allow the user to specify a new initialization vector at the column level for columns selected by the user for re-encryption, 3) allow the user to request for the generation of a new initialization vector at the row level for each row selected by the user for re-encryption, 4) allow the user to specify a new encryption key for use in the re-encryption of the column or row data selected by the user, 5) allow the user to specify a batch size for the re-encryption of the data selected by the user, 6) execute the re-encryption as specified by the user, 7) log the history of the encryption key usage to assist in data decryption of back-up data of the relational database at a later time, if so desired, and 8) allow the user to specify a different encryption mode, if desired.

According to certain embodiments, a mechanism is provided to allow the re-encryption of the user selected data to occur on a device that is separate from the relational database so as to not drain the computing and storage resources of the relational database. Such a mechanism can include a management console for managing the re-encryption of data specified by the user from the target relational database.

According to certain embodiments, the re-encryption of the database data that is selected for re-encryption is performed on a specialized piece of hardware that is designed to rapidly perform data encryption on large volumes of data from the relational database that is targeted for conversion to a secure system. Further, such a specialized piece of hardware is equipped with its own CPU and processing power in order to offload the database server that is associated with the target relational database. According to certain other embodiments, the re-encryption of the user selected data is performed by the target database server or by some other mechanism related to the target database.

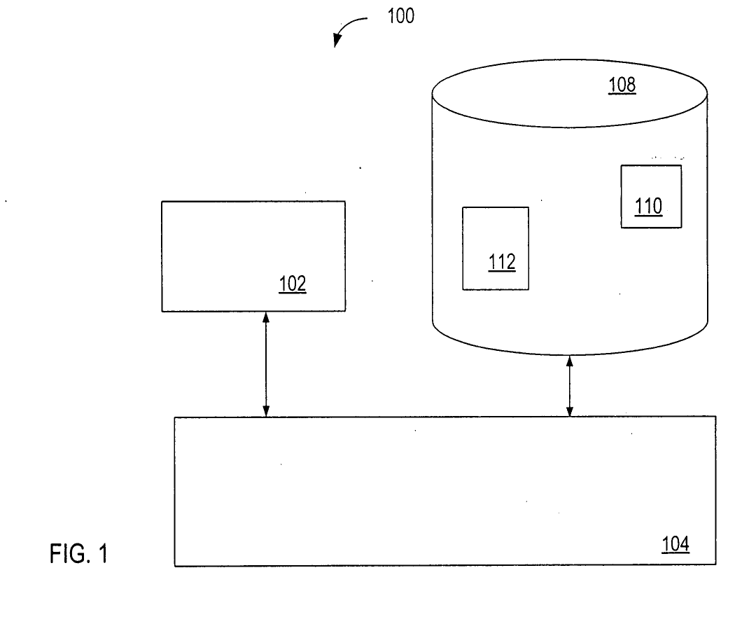

FIG. 1 is a high-level block diagram that illustrates system architecture for re-encryption of data that is previously encrypted in a database using an encryption mechanism that is separate from the database, according to certain embodiments. In architecture 100, a client computer 102 is capable of communicating with a cryptography server 114. Cryptography server communicates with relational database 108. Cryptography server includes, among other components, a CPU and processing power. The cryptography server can be used for storing information that includes but is not limited to information on database connection and access privileges to encrypted data.

Cryptography server 114 is also referred to as a network-attached cryptography server (NAE server). Relational database 108 includes, among other components, a plurality of data tables such as table 110 and a plurality of metadata tables such as metadata table 112. The metadata tables such as metadata table 112 in the relational database can be used for storing information that includes but is not limited to 1) each authorized user's access rights with respect to database tables and columns managed by the relational database, and 2) database table and column schema, 3) information on encryption methods, and 4) information on properties of tables and columns that are selected for encryption from the target database. The cryptography server retrieves target data selected by the user from the target relational database for re-encryption. The cryptography server then performs re-encryption on the user selected data using the new encryption key and/or new initialization vector selected by the user.

A user such as a security administrator or database administrator can use a client computer to manage the re-encryption process of data in the relational database by accessing a data management console associated with the cryptography server. According to certain embodiments, the data management console allows the user to login to a desired database server and select data for re-encryption. In certain other embodiments, the desired relational database may include a database provider and cryptography provider. According to certain embodiments, the database provider is that portion of the computer-implemented functionality that resides on the database server and that communicates with the NAE server. The cryptography provider communicates with the cryptography server to request for cryptography services. The cryptography provider is the API to the cryptography server, according to certain embodiments.

According to certain embodiments, the cryptography server, such as the NAE server, manages cryptography operations and encryption key management operations. The cryptography server allows a user or cryptography server client to perform cryptography operations including operations associated with the encryption and decryption of data, encryption keys, authentication, creation of digital signatures, generation and verification of Message Authentication Code (MAC).

According to certain embodiments, the cryptography server includes a key rotation tool that includes the following functionality: 1) allow a user to select one or more previously encrypted columns for re-encryption, 2) allow the user to specify a new initialization vector at the column level for columns selected by the user for re-encryption, 3) allow the user to request generation of a new initialization vector at the row level for each row selected by the user for re-encryption, 4) allow the user to specify a new encryption key for use in the re-encryption of the column or row data selected by the user, 5) allow the user to specify a batch size for the re-encryption of the data selected by the user, 6) execute the re-encryption as specified by the user, 7) log the history of the encryption key usage to assist in data decryption of back-up data of the relational database at a later time, if so desired, and 8) allow the user to specify a different encryption mode, if desired.

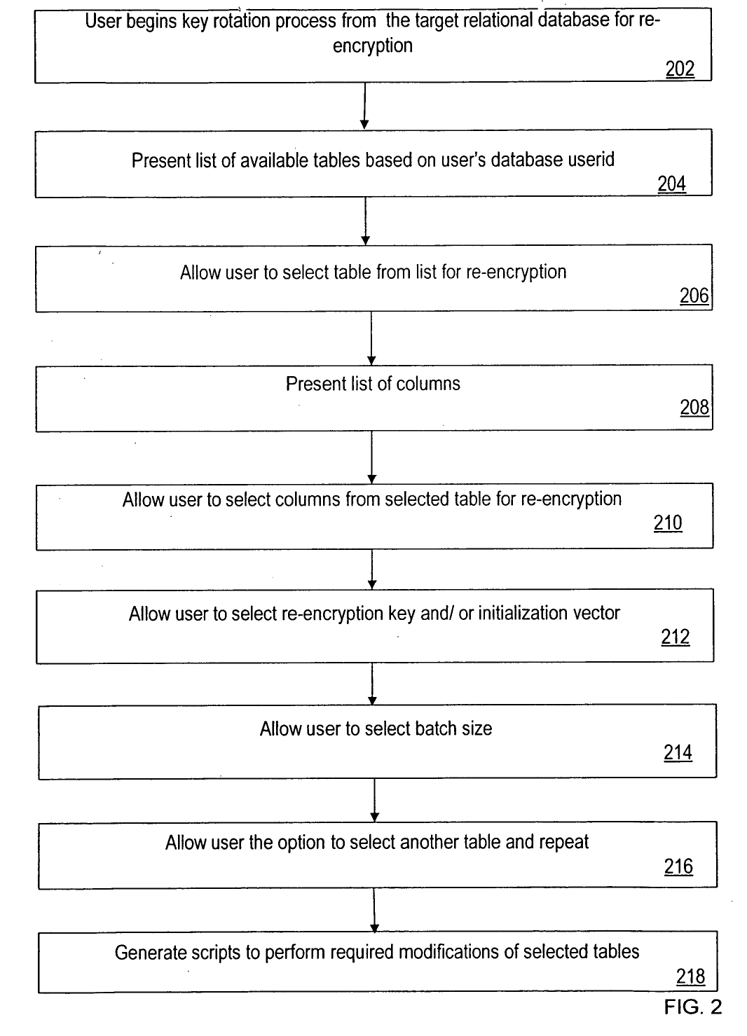

FIG. 2 is a flowchart that illustrates some of the steps that are performed for re-encrypting data in columns or rows in the target database that is selected by the user for re-encryption in a manner that has minimal impact on the target relational database.

At block 202 of FIG. 2, a user, such as a security administrator, or a database administrator, begins the data re-encryption process of selected column or row data (also referred to as target data) from the target relational database for purposes of re-encryption. According to certain embodiments, the user can begin the data re-encryption process by accessing a cryptography server, such as cryptography server 104 of FIG. 1. According to certain embodiments, the cryptography server may include an encryption key rotation tool with a front-end user interface. The front-end user interface of such a key rotation tool is herein also referred to as a data management console. The data management console allows the user to enter a specific set of data that is required to login to the target database. The specific set of data that is required for logging in may vary based on the database vendor. Thus, according to certain embodiments, the management console allows the user to specify the database type of the target database. Based on the database type, the management console can then present the login data fields for logging into the target database.

When the user's login information is submitted, an attempt to connect to the target database server is initiated. According to certain embodiments, if the connection attempt is successful, the database connection information is stored on the cryptography server. Such database connection information can be collected and stored for each type of database so that during future login attempts, the user can be presented with a login screen that requires a minimum amount of data entry for a selected target database.

If the connection attempt to connect with to the target database is unsuccessful, then the user may be presented with an error message and is allowed to re-enter login information.

At block 204 of FIG. 2, once connected to the target database of the user's choosing, the management console can then present a list of previously encrypted database tables that are available to the user for re-encryption, according to certain embodiments. According to certain embodiments, database metadata tables, such as metadata table 112, are queried based on the user's user id. The database metadata tables are queried based on user id in order to determine a list of database tables that have been previously encrypted by the user. The list of database tables that the user has previously encrypted is herein referred to as a target list of database tables. The target list of database tables is returned to the management console for presenting to the user.

At block 206 of FIG. 2, the user can select a database table from the target list of database tables for re-encryption. The database table that is selected by the user is herein referred to as the selected database table. The selected database table is sometimes referred to herein as a base table. At block 208 of FIG. 2, a list of columns is presented to the user. According to certain embodiments, the database metadata tables are queried based on the user's user id to determine the list of columns that were previously encrypted by the user in the selected database table. The list of columns in the selected database table that the user previously encrypted is herein referred to as a target list of columns. The target list of columns is returned to the management console for presenting to the user.

At block 210 of FIG. 2, the user is allowed to select the columns for re-encryption from the target list of columns. At block 212, the user is allowed to specify a new encryption key for each of the one or more selected columns. Optionally, in addition to selecting a new encryption key, the user is allowed to select a different encryption mode. The user is also allowed to select a new initialization vector for each of the one or more selected columns. If the user selects an initialization vector at the row level, then all columns in the selected database table will be encrypted using the new initialization vector and the newly selected encryption key, whether or not a given column in the selected database table was selected for key rotation. According to certain embodiments, the user's choices may be stored in the cryptography server for future reference.

At block 214, the user is allowed to specify a batch size for controlling the number of rows that are processed before being committed. At block 216 of FIG. 2, the user is allowed to select another table for re-encryption and the above process is repeated. At block 218, after the user has completed his or her selection of tables and columns for re-encryption, scripts may be generated to automatically perform the key rotation of the user's selected tables and columns from the target database to the cryptography server for re-encryption and other necessary modification. For example, a stored procedure for automating the decryption and re-encryption of a bulk load of selected data may be used. The stored procedure may be called from the database server, according to certain embodiments.

In the foregoing specification, embodiments of the invention have been described with reference to numerous specific details that may vary from implementation to implementation. The specification and drawings are, accordingly, to be regarded in an illustrative rather than a restrictive sense.

We claim:

1. A computer-implemented method, comprising:
selecting a previously encrypted column of a table for key rotation;
instantiating a view for accessing sensitive data in the previously encrypted column;
redirecting SQL statements directed to the table to the view;
performing re-encryption of the sensitive data in the previously encrypted column.

2. The computer-implemented method of claim 1, further comprising:
using one or more triggers for creating new corresponding SQL statements based on the SQL statements.

3. The computer-implemented method of claim 1, further comprising:
using one or more triggers for redirecting the SQL statements.

4. The computer-implemented method of claim 3, further comprising:
automatically creating the one or more triggers based on one or more metadata tables, wherein the one or more metadata tables are configurable for defining database tables and columns that are targeted for encryption.

5. The computer-implemented method of claim 1, wherein the SQL statements include insert statements, update statements, and delete statements.

6. A computer-implemented method for allowing an application program to access sensitive data in a database in a manner that is transparent to the application program and the database, the method comprising:
instantiating a view, when the application program attempts to access the sensitive data, wherein the view corresponds to a source column in the database and wherein the source table is where the sensitive data resides as encrypted data;
decrypting the sensitive data;
populating the view with decrypted data corresponding to the sensitive data if the application program is authenticated;
revealing the view to the authenticated application program;
selecting at least one previously encrypted column for key rotation;
performing re-encryption of the sensitive data in the at least one selected previously encrypted column.

7. The computer-implemented method of claim 6, further comprising:
trapping SQL statements from the application program directed to the source table by using one or more triggers.

8. The computer-implemented method of claim 7, further comprising:
automatically creating the one or more triggers based on one or more metadata tables, wherein the one or more metadata tables are configurable for defining database tables and columns that are targeted for encryption.

9. The computer-implemented method of claim 7, wherein the SQL statements include insert statements, update statements, and delete statements.
